(19) United States
(12) Patent Application Publication
(10) Pub. No.: US 2017/0333867 A1
(43) Pub. Date: Nov. 23, 2017

(54) Sorbents for Recovery of Lithium Values from Brines

(71) Applicant: Albemarle Corporation, Baton Rouge, LA (US)

(72) Inventors: Chi Hung Cheng, Baton Rouge, LA (US); Jan Nieman, Maarssen (NL); Gregory Alan Marus, Baton Rouge, LA (US)

(21) Appl. No.: 15/522,829

(22) PCT Filed: Oct. 16, 2015
(86) PCT No.: PCT/US2015/056095

§ 371 Date: Apr. 28, 2017

Related U.S. Application Data
(60) Provisional application No. 62/072,849, filed on Oct. 30, 2014.

(51) Int. Cl. B01J 20/04; C22B 7/00; B01J 20/08; C01D 15/04; B01J 20/30; B01J 20/28; C22B 26/12; B01J 20/34

(52) U.S. Cl. CPC B01J 20/046; C22B 26/12; C22B 7/006; B01J 20/3433; C01D 15/04; B01J 20/3475; B01J 20/041; B01J 20/3085; B01J 20/28059; B01J 20/28016; B01J 20/08; C01P 2006/80

(57) ABSTRACT

Processes are disclosed for the preparation of granular sorbent, useful to recover lithium values from brine. The process comprises reacting a granular aluminum hydroxide with an aqueous solution containing lithium salt and alkali hydroxide, optionally in the presence of alkali chloride. The granular aluminum hydroxide can be a compressed aluminum hydroxide having an average particle size of at least 300 microns. The granular sorbent obtained by the method and its use to recover lithium values from brine are disclosed.

### FIELD OF THE INVENTION

The invention relates to the field of lithium recovery, and in particular, to the recovery of lithium values such as LiCl from brines. In particular, the invention relates to sorbents for recovering lithium values from brines, their preparation, and their use.

### BACKGROUND AND PRIOR ART

Lithium is valuable in a number of industrial uses, for example in the manufacture of lithium batteries, and improvements in methods for its recovery are continually being sought.

It is known in the prior art to recover lithium from brine solutions. One approach in the prior art has been the use of microcrystalline lithium aluminates formed within ion exchange resins, to extract lithium values from lithium-containing brines. Another approach has been the use of sorbent pellets which comprise aluminum hydroxide into which lithium salts have been introduced.

Sorbent pellets for recovering lithium from brine, and their use, are disclosed in U.S. Pat. No. 5,389,349. This patent discloses preparation of LiCl.2Al(OH)₃ by contacting aluminum hydroxide with an aqueous solution of lithium chloride that is saturated with sodium chloride. A maximum loading of 0.2 mol fraction of lithium chloride was reported (further lithium loading caused pellet breakage). It is disclosed that the particle size of the pellets is not smaller than about 140 mesh (US standard Sieve Size).

U.S. Pat. No. 5,599,516 and U.S. Pat. No. 6,280,693 disclose the preparation of sorbent pellets for recovering lithium from brine and their use. These patents disclose polycrystalline hydrated alumina pellets based on a hydrated alumina such as crystalline gibbsite, bayerite, nordstrandite or bauxite. The pellets are morphologically altered by the infusion therein of LiOH (lithium hydroxide), in the absence of sodium chloride, which creates active lithium-specific sites within the crystal layers of the alumina. The infused alumina pellets, having the formula LiOH-2Al(OH)₃ and lithium loading up to 0.33 mol fraction, are converted to LiCl.2Al(OH)₃ by neutralization with HCl, and can then be used in the process of removing lithium values from brine. It is disclosed that the particle size of the pellets is not smaller than about 140 mesh (US Standard Sieve Size).

These prior art methods require a very gentle and slow infusion of the lithium hydroxide into the aluminum hydroxide crystal layer in order to achieve high lithium loading without fracturing the particles. Deterioration of the particles can also occur during the neutralization step carried out in an agitated vessel, and by use of the sorbent in packed columns for the recovery of lithium from brine, thereby shortening the useful life of the sorbent.

U.S. Pat. No. 8,753,594 discloses a composition for recovery of lithium from brine, which comprises a lithium aluminum intercalate mixed with a polymer material.

Recovery of lithium values from brine solutions is disclosed in US Published Application 2012/0141342.

### SUMMARY OF THE INVENTION

The invention seeks to improve upon the sorbents known in the prior art for extracting lithium values from brine solutions and to improve upon and economize the process of sorbent preparation. In particular embodiments, the invention provides sorbent particles which are characterized by their structural strength, low amounts of fines, high sorption capacity, and economy of preparation and use.

In certain embodiments, the invention comprises a process for the preparation of a granular sorbent of the formula (LiOH)ₐ(LiX)₁₋ₐ.2Al(OH)₃, where X=is the anion moiety of a lithium salt, such as chloride, bromide, nitrate or sulfate, and a=0-1, preferably 0.5-0.95, and most preferably 0.7-0.85, which comprises reacting an aqueous solution which contains lithium salt and alkali hydroxide, optionally in the presence of sodium salt, with granular aluminum hydroxide to form a granular sorbent of the formula (LiOH)ₐ(LiX)₁₋ₐ.2Al(OH)₃, having a lithium to aluminum ratio of up to about 0.50 theoretical maximum. The lithium aluminum intercalate is then neutralized with acid (HX) to convert the lithium hydroxide in the intercalate to LiX to produce a sorbent having the formula LIX.2Al(OH)₃, wherein the acid is preferably HCl. In preferred embodiments, the aqueous solution contains lithium chloride and sodium hydroxide, optionally in the presence of sodium chloride. Use of lithium salt/alkali hydroxide solutions in accordance with these embodiments allows for economical yet effective preparation of a sorbent useful for lithium extraction from brines.

In further embodiments of the invention, a process is provided for the preparation of a granular sorbent of the formula (LiOH)ₐ(LiX)₁₋ₐ.2Al(OH)₃, where X is the anion moiety of a lithium salt, a=0-1, preferably 0.5-0.95, most preferably 0.7-0.85, having a lithium to aluminum ratio of up to about 0.50, comprising intercalating lithium into a granular aluminum hydroxide having an average particle size of at least 300 microns and which has been morphologically altered by compression. Granular aluminum hydroxide having this specified average particle size and morphological alteration is referred to herein as “compressed ATH.” Preferably, the compressed ATH has a surface area of at least 3 m²/g. The lithium aluminum intercalate so formed is then neutralized with an acid solution (HX) to convert the lithium hydroxide in the intercalate to LiX to produce a sorbent having the formula LiX.2Al(OH)₃, wherein the acid is preferably HCl. The inventors have found that use of compressed ATH allows for preparation of a sorbent which possesses exceptionally good sorbent characteristics, in particular, large particle size with high surface area, rapid intercalation rate, and durable particle integrity. In these embodiments, lithium ions intercalate into the ATH at a rapid rate with high degree of ATH conversion, while particle integrity is maintained and formation of fines is minimized. When the sorbent is loaded in a column, the efficiency of the sorption-desorption process is sustained at high flow rates with low pressure drop. Furthermore, in the embodiments utilizing compressed ATH, the neutralization of the lithium hydroxide to lithium chloride in the intercalate can occur in a column, where the sorbent is neutralized by circulating a liquid containing acid such as hydrochloric acid at a high flow rate with low pressure drop. This substantially prevents or even eliminates formation of fines that is experienced when the neutralization is carried out in a stirred reaction vessel.

Further preferred embodiments provide a process for the preparation of a granular sorbent of the formula (LiOH)ₐ(LiX)_{1-z}.2Al(OH)₃, where X is the anion moiety of a lithium salt, a=0-1, preferably 0.5-0.95, most preferably 0.7-0.85, having a lithium to aluminum molar ratio of up to about 0.50 theoretical maximum, comprising reacting an aqueous solution which contains lithium salt and alkali hydroxide, optionally in the presence of alkali chloride, with granular aluminum hydroxide having an average particle size of at least 300 microns and which has been morphologically altered by compression. In this embodiment, the lithium salt is preferably lithium chloride, the alkali hydroxide is preferably sodium hydroxide, and the alkali chloride, if present, is preferably sodium chloride. The product is reacted with an acid (HX) to convert LiOH in the sorbent to LiX, where HX is preferably hydrochloric acid.

In further embodiments, the invention comprises a sorbent for recovering lithium from brine, made by one of the processes as described.

In a still further aspect, the invention comprises a process for removing lithium from a lithium-containing brine, which comprises contacting a lithium-containing brine with a sorbent made by one of the processes as described.

Further characteristics and advantages of the invention will be apparent from the following detailed description.

### DESCRIPTION OF THE DRAWINGS

FIG. 1 is a graph showing lithium remaining in solution over time (days) during preparation of sorbent using compacted ATH in comparison to another type of aluminum hydroxide.

FIG. 2 is a graph showing lithium remaining in solution over time (hours) during preparation of sorbent using compacted ATH in comparison to another type of aluminum hydroxide.

FIG. 3 is a graph showing the kinetics of neutralization of a sorbent according to the invention with hydrochloric acid.

### DESCRIPTION OF PREFERRED EMBODIMENTS

In a first embodiment of the invention, a solution of lithium salt and alkali hydroxide, optionally in the presence of alkali chloride, is used for the loading of lithium by intercalation into granular aluminum hydroxide to generate double aluminum lithium hydroxide chloride of the formula (LiOH)ₐ(LiX)₁₋ₐ.2Al(OH)₃, where X is the anion moiety of a lithium salt, a=0-1, preferably 0.5-0.95, and more preferably 0.7-0.85, and having a lithium to aluminum molar ratio of up to about 0.50. The lithium-loaded material is then neutralized with acid (HX), preferably hydrochloric acid, to convert LiOH to LiX. In these embodiments, the lithium salt is preferably lithium chloride, the alkali hydroxide is preferably sodium hydroxide, and the optional sodium salt, if present, is preferably sodium chloride. It is noted that LiCl solutions and LiCl/NaCl solutions are readily available in a plant environment where lithium chloride is extracted from brine. The use of a solution of lithium salt and alkali hydroxide, optionally in the presence of alkali chloride, is economical yet effective for loading lithium into granular aluminum hydroxide in relation to prior art chemistries, for example using solutions of lithium hydroxide. In these embodiments, the granular aluminum hydroxide may comprise any form of granular aluminum hydroxide (such as Gibbsite, Bayerite, Nordstrandite or Bauxite materials), but preferably comprises compressed ATH as described below.

The granular aluminum hydroxide is reacted with the aqueous solution containing lithium salt and alkali hydroxide, optionally in the presence of alkali chloride, under conditions such that lithium is intercalated into the structure of the granular aluminum hydroxide to a desired loading. The lithium salt and alkali hydroxide solution should be of sufficient amount and concentration to intercalate lithium into the aluminum hydroxide so as to provide a lithium aluminate intercalate having lithium to aluminum molar ratio from about 0.25 to 0.50 (where 0.50 is the theoretical maximum). For example, the solution may contain a lithium salt concentration of 5 to 12 weigh percent, preferably 6 to 11 weight percent. The ratio of lithium salt to granular Al(OH)₃ is about 0.3-1.0:1, preferably 0.4-0.8:1 molar. The ratio of alkali hydroxide to granular Al(OH)₃ is about 0.3-1.0:1 molar, preferably 0.3-0.8:1 molar. The ratio of alkali chloride, if present, to granular Al(OH)₃ is about 0.3-1.0:1 molar.

The intercalation process is enhanced by heating and a preferred temperature range for the reaction is 20-100° C., preferably 50-90° C.

In further embodiments of the invention, the granular aluminum hydroxide has an average particle size of at least 300 microns and has been morphologically altered by compression (compressed ATH). This embodiment comprises a process for the preparation of a granular sorbent of the formula (LiOH)ₐ(LiX)₁₋ₐ.2Al(OH)₃, where X is the anion moiety of a lithium salt, a=0-1, preferably 0.5-0.95, and more preferably 0.7-0.85, having a lithium to aluminum molar ratio of up to about 0.50, comprising intercalating lithium into a granular aluminum hydroxide which has an average particle size of at least 300 microns and has been morphologically altered by compression. In this embodiment, any known chemistry for intercalating lithium into the granular aluminum hydroxide may be employed, such as the chemistries disclosed in U.S. Pat. No. 5,389,349, U.S. Pat. No. 6,280,693, and U.S. Pat. No. 8,753,594, each of which is incorporated by reference. Preferably, however, the intercalation is performed by reacting the compressed ATH with an aqueous solution containing lithium salt (preferably LiCl) and alkali hydroxide (preferably NaOH), optionally in the presence of alkali chloride (preferably NaCl), as described above. In the compressed ATH embodiments, the loading of the lithium into the compressed ATH proceeds very rapidly.

Compressed ATH is a form of granular Al(OH)₃, which as defined herein is characterized by a relatively large particle size (average particle diameter at least, and preferably greater, than 300 microns) and a morphological alteration to the ATH caused by compression. In particular, the aluminum hydroxide has been compressed (usually by rollers) prior to heat activation. Compressed ATH is normally made from a series of steps, including compression (e.g. by rollers), crushing (e.g. in a hammer mill), then sieving (to a desired particle size range). In the case of the present process, the desired particle size range is 300 to about 2000 microns, more preferably 300-1000 microns. Average particle size is readily determined by those skilled in the art. Undersize particles should be less than a few percent of total particles. The compacting step increases particle size and alters the morphology of the particles to increase their performance of lithium loading and unloading. Suitable compressed aluminum hydroxide and its preparation are disclosed in, for example, U.S. Pat. No. 4,083,911, the disclosure of which is incorporated by reference. A suitable and preferred material is commercially available under the trade name Compalox ON/V801 from Albemarle Corporation. The compressed, granular aluminum hydroxide exhibits high mechanical strength, which is desirable in the context of this invention to prevent damage to the sorbent particles during their preparation and use. In addition, the strength of the granular aluminum oxide allows the granulate to be loaded with lithium up to the theoretical maximum loading capacity without disintegration or damage, and allows for extended life of the particles as a sorbent. Accordingly, the most preferred embodiments of the invention are sorbents prepared using compressed ATH.

As is known to those skilled in the art, aluminum oxide granulates may contain trace or minor amounts of other materials (e.g. other metals) which do not impact performance.

In still further embodiments, a process is provided for the preparation of a granular sorbent of the formula (LiOH)ₐ(LiX)₁₋ₐ.2Al(OH)₃, where X is the anion moiety of a lithium salt, a=0-1, preferably 0.5-0.95, more preferably 0.7-0.85, having a lithium to aluminum molar ratio of up to about 0.50 theoretical maximum, comprising reacting an aqueous solution which contains lithium salt and alkali hydroxide, optionally in the presence of alkali chloride, with granular aluminum hydroxide having an average particle size of at least 300 microns and has been morphologically altered by compression. In this embodiment, the lithium salt is preferably lithium chloride, the alkali hydroxide is preferably sodium hydroxide, and the alkali chloride, if present, is preferably sodium chloride. The granular aluminum hydroxide preferably has a surface area of at least 3 m²/g. The sorbent is reacted with HX to convert LiOH in the sorbent to LiX, with HX preferably being hydrochloric acid.

In all of the various embodiments of making a sorbent, the intercalation reaction is performed in any suitable reactor, which may be a fixed bed, a column or the like. Contact is maintained for a period sufficient for the desired degree of loading, for example 1-100 hours, preferably 5-30 hours. As shown in the examples which follow, the reaction time required for loading is reduced when the granular aluminum hydroxide is compressed ATH. The loading reaction may be monitored by determining the concentration of lithium remaining in the liquid phase as the reaction progresses. Using the compressed ATH embodiments of the invention, intercalation of up to 0.45-0.50 lithium to aluminum molar ratio is reliably achieved, with only low particle deterioration and low formation of fines (less than 1%).

In all embodiments of making a sorbent, at the completion of lithium loading, the sorbent is neutralized with an acid, preferably hydrochloric acid. Treatment with hydrochloric acid solution converts LiOH in the sorbent into LiCl. The neutralization reaction is complete when the pH of the neutralizing solution exposed to the sorbent is reduced to about 5.0. Advantageously, the neutralization reaction may be carried out in the same reaction vessel as the loading reaction. In a preferred embodiment, both the loading reaction and the neutralization reaction are performed in the same column, with the successive solutions being passed through a bed of the particulate sorbent. The use of a column for these reactions, in comparison to an agitated vessel, reduces or eliminates the formation of undesired fines.

Sorbents prepared as described by the above methods are useful for the recovery of lithium values, such as LiCl, from brines, using any technique of contacting the sorbent with the lithium-containing brine. See, e.g. Isupov et al, Studies in Surface Science and Catalysis, 1998, Vol. 120, pp. 621-652; U.S. Pat. No. 5,389,349; U.S. Pat. No. 5,599,516; U.S. Pat. No. 6,280,693; U.S. Pat. No. 3,306,700; US Published Application No. 2012/0141342; U.S. Pat. No. 4,472,362; and U.S. Pat. No. 8,753,594, the disclosure of each of which is incorporated by reference herein. For use in repeated cycles of lithium extraction, the sorbent is washed with water to unload the lithium.

As noted, the compressed ATH embodiments of the invention allow for preparing sorbents having high lithium loading capacity while maintaining particle integrity during sorbent preparation, use and regeneration. The large diameter size of the sorbent in these embodiments facilitates use of the sorbent as bed within a reaction column while avoiding the high pressure drop associated with use of smaller-sized particles, permitting higher flow rates and reduced equipment and operating costs.

Any lithium-containing brine may be treated in accordance with the invention, including seawater and subterranean brines. The brine may comprise the effluent from a prior treatment operation.

### EXAMPLES

The following examples illustrate currently preferred embodiments of the invention and should be construed as illustrative and not limiting on the scope of the invention.

### Example 1

In this example, compressed ATH is reacted with LiCl/caustic solution to produce a sorbent. The molar ratio of LiCl:NaOH:ATH=0.5:0.5:1 molar ratio, and 9.5% LiCl.

A 234 g (3.0 mol) portion of Compalox ON/V-801 was reacted with 670 g of a solution containing 9.5 wt % LiCl (1.5 mol) and 9.0 wt % NaOH (1.5 mol) in a 1 liter plastic bottle which was placed in an oven at 70° C. After 5 hours, the content was filtered. The filtrate contained 2079 ppm Li and the wet solids contained 2.29% Li and 19.75 wt % Al (0.45 lithium to aluminum molar ratio). The particle size data of the solids is shown in Table 1.

### Example 2

In this example, compressed ATH is reacted with LiCl/caustic solution to produce a sorbent. The molar ratio of LiCl:NaOH:ATH=0.5:0.4:1 and 8.0 wt % LiCl.

A 546 g (7.0 mol) portion of Compalox ON/V-801 was reacted with 1855 g of a solution containing 8.0 wt % LiCl (3.5 mol) and 6.0 wt % NaOH (2.8 mol) in two 1-liter plastic bottles placed in an oven at 70° C. After 24 hours, the combined contents of the bottles was filtered. The filtrate contained 1710 ppm Li and the wet solids (818 g) contained 2.69% Li and 23.25 wt % Al (0.45 lithium to aluminum molar ratio). The particle size data of the solids is shown in Table 1.

### Example 3

In this example, compressed ATH is reacted with LiCl/caustic solution to produce a sorbent. The molar ratio of NaCl, LiCl:NaOH:ATH=0.55:0.4:1, and 7.0% LiCl.

A 246 g (3.15 mol) portion of Compalox ON/V-801 was reacted with 1049 g solution containing 7.0 wt % LiCl (1.73 mol), 4.8 wt % NaOH (1.26 mol), and 7.0% NaCl in a 1 liter plastic bottle placed in an oven at 70° C. After 50 hours, the content was filtered. The filtrate contained 1860 ppm Li and the wet solids contained 2.74% Li and 22.8 wt % Al (0.47 lithium to aluminum molar ratio). The particle size data of the solids is shown in Table 1.

TABLE 1

| Particle | ON/V-801 | LiX•2Al(OH)₃ | LiX•2Al(OH)₃ | LiX•2Al(OH)₃ |
|---|---|---|---|---|
| Size^{BC} | Al(OH)₃ | Example 1 | Example 2 | Example 3 |
| <101 um | 2.6 | 4.6 | 1.3 | 1.4 |
| (%) | | | | |
| D10 (um) | 388 | 165 | 310 | 306 |
| D50 (um) | 594 | 346 | 583 | 581 |
| D90 (um) | 831 | 580 | 892 | 886 |

BC = Beckman-Coalter laser diffraction particle size analyzer

### Example 4

Commercially available Gibbsite was reacted with LiCl and caustic solution, at a molar ratio of LiCl:NaOH:ATH=0.5:0.5:1, and 9.2% LiCl.

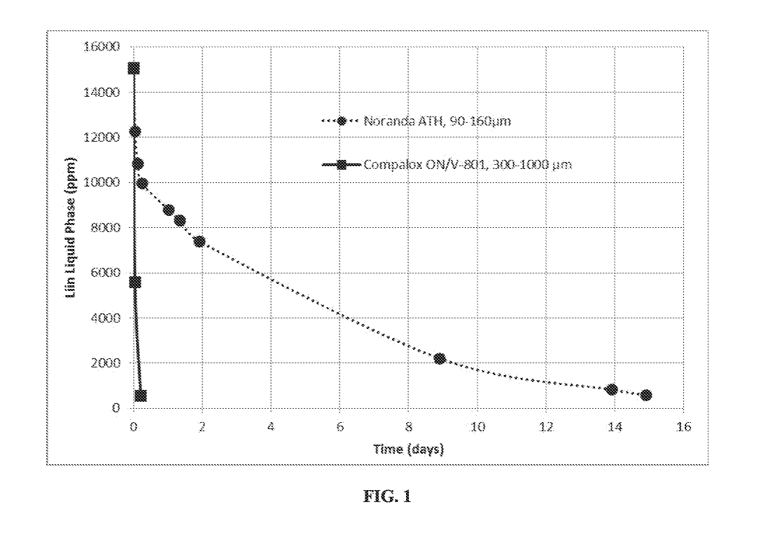

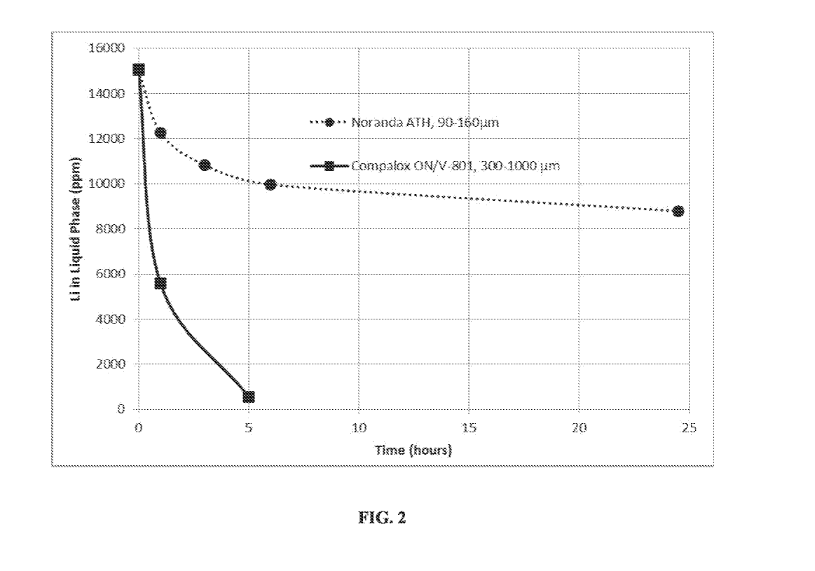

A 234 g (3.0 mol) portion of ATH from Noranda (sieve fraction 90-160 μm) was reacted with 692 g of a solution containing 9.2 wt % LiCl (1.5 mol) and 8.7 wt % NaOH (1.5 mol) in a closed 1 liter plastic bucket placed in an oven at 70° C. (Ika KS 4000i). The mixture was homogenized after 0.5 h and 1 h. Thereafter liquid samples were taken regularly after homogenization and the Li in liquid phase was analyzed by ion chromatography to monitor Li intercalation over time. See FIGS. 1 and 2. After 358 hours, the content was decanted (liquid contained 3.8 grams of fines) and thereafter filtered. The filtrate contained 572 ppm Li and the wet solids contained 2.31% Li and 18.64 wt % Al.

### Example 5

Compressed ATH is activated with LiCl and caustic solution, at a molar ratio of LiCl:NaOH:ATH=0.5:0.5:1, and 9.2% LiCl

A 234 g (3.0 mol) portion of Compalox ON/V-801 was reacted with 692 g of a solution of 9.2 wt % LiCl (1.5 mol) and 8.7 wt % NaOH (1.5 mol) in a closed 32 oz. plastic bucket placed in an oven at 70° C. (Ika KS 4000i). Liquid samples were taken regularly after homogenization and Li in liquid phase was analyzed by ion chromatography to monitor Li intercalation over time. See FIGS. 1 and 2. After 5 hours, the content was filtered. The filtrate contained 560 ppm Li and the wet solids contained 2.47 wt % Li and 20.73 wt % Al.

When the results of Example 4 and Example 5 are compared, as shown in FIGS. 1 and 2, it can be appreciated that the intercalation of lithium proceeds much faster using compressed ATH. Furthermore, microscopic inspection of the sorbent produced in Example 5 revealed that particle integrity was essentially completely maintained during loading.

### Example 6

This example illustrates neutralization of (LiOH)ₐ(LiCl)₁₋ₐ.2Al(OH)₃ with hydrochloric acid in a column.

A 2″ diameter jacketed glass column was loaded with a 798 g portion (6.87 mol Al) of the wet solids from Example 2. Water was then fed to the bed upflow at 500 ml/min to remove any fine particles from the bed and until the effluent was clear. The effluent was filtered and 4.6 g and <0.6% of fine particles were recovered.

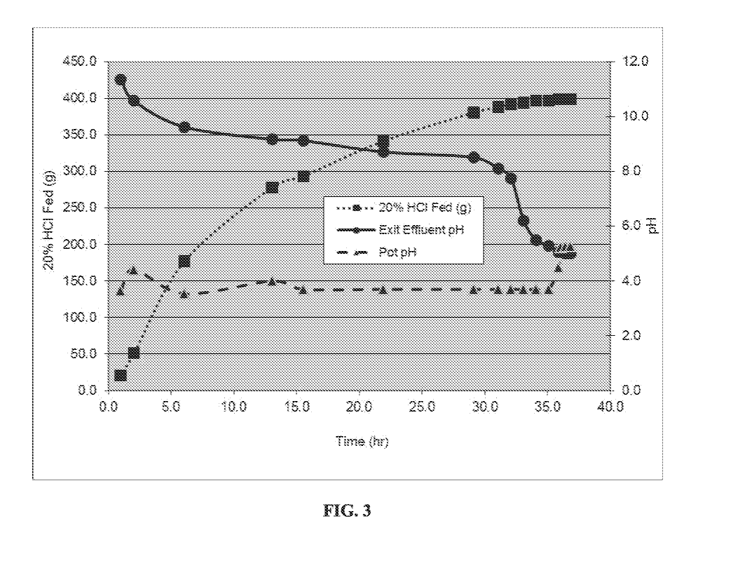

Water was then circulated upflow through the column at a constant rate of 600 ml/min, while maintaining the column at 70° C. A 20% solution of hydrochloric acid was then fed via a metering pump to the water recirculation pot to maintain a 3.5-5.0 pH value of the water being fed to the column. The neutralization was complete after about 36 hours, when the pH of the water effluent exiting the column dropped to 5.0. See FIG. 3. During the neutralization 3.6 g of fine particles were collected (about 0.4% of what was initially loaded into the column). 811.7 g of wet solids were unloaded from the column, and analysis of those solids determined that they contained 22.6% Al (6.79 mol) and 2.04% Li (2.39 mol).

### Example 7

This example confirms the utility of the sorbent of the invention to recover lithium values from brine. A 665.8 g portion (5.57 mol Al) of the solids from Example 6 was loaded into a 1″ diameter jacketed column for testing of the sorbent to recover LiCl value from brine.

The composition of the tested brine was: 0.122% LiCl, 15% NaCl, 8.3% CaCl₂, 0.2% B(OH)₃, 1.1% MgCl₂, and 0.36% SrCl₂.

To partially unload the lithium from the sorbent, to prepare the sorbent to recover LiCl from brine, 4.6 liter of water that contained 0.3% LiCl at 70° C. was upflowed through the sorbent at a constant flow rate of 60 g/min. The water was drained to the bed level by gravity. The water holdup in the bed was displaced with a void volume of brine by gravity.

For the first cycle, 8.8 liter of brine was upflowed through the column at 70° C. at a constant flow rate of 50 g/min. Recovery of lithium value from the feed brine in this cycle was 87%. The settled bed height was 43 inch. The brine was drained to the bed level by gravity, and the brine holdup in the bed was displaced with a saturated NaCl solution.

An additional 60 g of the solids from Example 5 as loaded to the column to increase the bed height to about 4 feet. 5.3 liter of water containing 0.18% LiCl at 70° C. was upflowed at a constant flow rate of 60 g/min to unload LiCl from the sorbent. Water was drained to the bed level by gravity. The water holdup in the bed was displaced with a void volume of brine by gravity.

For the second cycle, 11.14 liters of brine was upflowed through the column at 70° C. at a constant flow rate of 50 g/min. Recovery of lithium value from the feed brine in this cycle was 91%. The settled bed height was about 4 ft.

The above cycle was repeated 16 times and no reduction in the sorbent performance was observed.

1. A process for the preparation of a granular sorbent of the formula (LiOH)ₐ(LiX)₁₋ₐ.2Al(OH)₃, where a=0-1, X is the anion moiety of a lithium salt, having a lithium to aluminum molar ratio of up to about 0.50, comprising reacting an aqueous solution which contains lithium salt and alkali hydroxide, optionally in the presence of sodium salt, with granular aluminum hydroxide.

2. The process of claim 1, wherein the lithium salt is lithium chloride, the alkali hydroxide is sodium hydroxide, and the optional sodium salt, if present, is sodium chloride.

3. The process of claim 2, wherein the granular aluminum hydroxide has an average particle size of at least 300 microns and has been morphologically altered by compression.

4. The process of claim 3, wherein the granular aluminum hydroxide has a surface area of at least 3 m²/g.

5. The process of claim 1, wherein the aluminum hydroxide is Gibbsite.

6. The process of claim 1, wherein a=0.7-0.85.

7. A process for the preparation of a granular sorbent of the formula (LiOH)ₐ(LiX)₁₋ₐ.2Al(OH)₃, where a=0-1, X is the anion moiety of a lithium salt, having a lithium to aluminum molar ratio of up to about 0.50, comprising intercalating a lithium salt into a granular aluminum hydroxide which has an average particle size of at least 300 microns and has been morphologically altered by compression.

8. The process of claim 7, wherein the granular aluminum hydroxide has a surface area of at least 3 m²/g.

9. The process of claim 7, wherein lithium is intercalated into the granular aluminum hydroxide by reacting the granular aluminum hydroxide with an aqueous solution which contains lithium salt and alkali hydroxide, optionally in the presence of alkali chloride.

10. The process of claim 9, wherein the lithium salt is lithium chloride, the alkali hydroxide is sodium hydroxide, and the alkali chloride, if present, is sodium chloride.

11. The process of claim 7 where a=0.7-0.85.

12. A process for the preparation of a granular sorbent of the formula (LiOH)ₐ(LiX)₁₋ₐ.2Al(OH)₃, where X is the anion moiety of a lithium salt, a=0-1, having a lithium to aluminum molar ratio of up to about 0.50, comprising reacting an aqueous solution which contains lithium salt and alkali hydroxide, optionally in the presence of alkali chloride, with granular aluminum hydroxide having an average particle size of at least 300 microns and has been morphologically altered by compression.

13. The process as claimed in claim 12, wherein the lithium salt is lithium chloride, the alkali hydroxide is sodium hydroxide, and the alkali chloride, if present, is sodium chloride.

14. The process of claim 12 wherein the granular aluminum hydroxide has a surface area of at least 3 m²/g.

15. The process of claim 12, wherein a=0.7-0.85.

16. The process of claim 1, further comprising reacting the sorbent with an acid (HX), where X is the anion moiety of the acid, to convert LiOH in the sorbent to LiX.

17-18. (canceled)

19. The process of claim 7, further comprising reacting the sorbent with an acid (HX), where X is the anion moiety of the acid, to convert LiOH in the sorbent to LiX.

20.-21. (canceled)

22. The process of claim 12, further comprising reacting the sorbent with an acid (HX), where X is the anion moiety of the acid, to convert LiOH in the sorbent to LiX.

23. The process of claim 22, wherein the acid is HCl.

24. The process of claim 22, wherein the reaction of the sorbent with HX is carried out in a column.

25-27. (canceled)

28. A granular sorbent produced by the method of claim 16.

29. A granular sorbent produced by the method of claim 19.

30. A granular sorbent produced by the method of claim 22.

31. A process of recovering lithium values from a lithium-containing brine, which comprises contacting the lithium-containing brine with the granular sorbent of claim 28.

32. A process of recovering lithium values from a lithium-containing brine, which comprises contacting the lithium-containing brine with the granular sorbent of claim 29.

33. A process of recovering lithium values from a lithium-containing brine, which comprises contacting the lithium-containing brine with the granular sorbent of claim 30.
